(19) United States
(12) Patent Application Publication
(10) Pub. No.: US 2014/0070961 A1
(43) Pub. Date: Mar. 13, 2014

(54) APPARATUS AND METHOD FOR ELECTRONICALLY DISSEMINATING INFORMATION TO STREET TRAFFIC

(71) Applicants: Benjamin Collar, Austin, TX (US); James Kelly Allen, Austin, TX (US)

(72) Inventors: Benjamin Collar, Austin, TX (US); James Kelly Allen, Austin, TX (US)

(73) Assignee: SIEMENS INDUSTRY, INC., Alpharetta, GA (US)

(21) Appl. No.: 13/606,489

(22) Filed: Sep. 7, 2012

(51) Int. Cl. G08G 1/0967; G08G 1/00

(52) U.S. Cl. 340/902; 340/905

(57) ABSTRACT

The present disclosure is directed to traffic control systems that electronically disseminate locally relevant information to street traffic. Various embodiments relate to systems and methods for supplying a network connection from a traffic controller system in a traffic controller cabinet to an electronic display. Various embodiments include TCC systems, methods, and mediums that control a traffic signal using traffic control circuitry, display selected display content on an electronic display, basing the selection on several factors, including information regarding the controlled traffic signal. The various embodiments also communicate with the network that is coupled to the traffic control circuitry, all while protecting the electronic display from environmental factors.

### TECHNICAL FIELD

The present disclosure is directed, in general, to traffic control systems, and more specifically to electronically disseminating locally relevant information to street traffic.

### BACKGROUND OF THE DISCLOSURE

Increasing populations and high demand for travel have resulted in more street intersections controlled by traffic signals. Traffic signal controlled intersections are generally accompanied by large metal boxes located near the intersection. The large, usually metal cabinet (“traffic controller cabinet” or “TCC”) contains a traffic control system. It would be desirable to use traffic controller cabinets for more than just traffic signal control.

### SUMMARY OF THE DISCLOSURE

Various disclosed embodiments relate to systems and methods for supplying a network connection from a traffic controller system in a traffic controller cabinet (“TCC”) to an electronic display.

Various embodiments include TCC systems, methods, and mediums. A method includes controlling a traffic signal using traffic control circuitry. The method includes displaying selected display content on an electronic display, which is coupled to the traffic control circuitry. The selection is based on several factors, including information regarding the controlled traffic signal. The method includes communicating with a network that is coupled to the traffic control circuitry. Additionally, the method includes covering and protecting the electronic display from environmental factors using a substantially transparent shield.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a traffic signal controlled street intersection in which an embodiment of the present disclosure can be implemented;

FIG. 2 illustrates a diagram of a traffic control cabinet in accordance with disclosed embodiments;

FIG. 3 illustrates one embodiment of electrical circuitry inside a traffic control cabinet in which an embodiment of the present disclosure can be implemented;

FIG. 4 illustrates another embodiment of electrical circuitry inside a traffic control cabinet in which an embodiment of the present disclosure can be implemented;

FIG. 4A illustrates an embodiment of a controller inside a traffic control cabinet in which an embodiment of the present disclosure can be implemented;

FIG. 5 illustrates a first flowchart of a process in accordance with disclosed embodiments; and

FIG. 6 illustrates a second flowchart of a process in accordance with disclosed embodiments.

### DETAILED DESCRIPTION

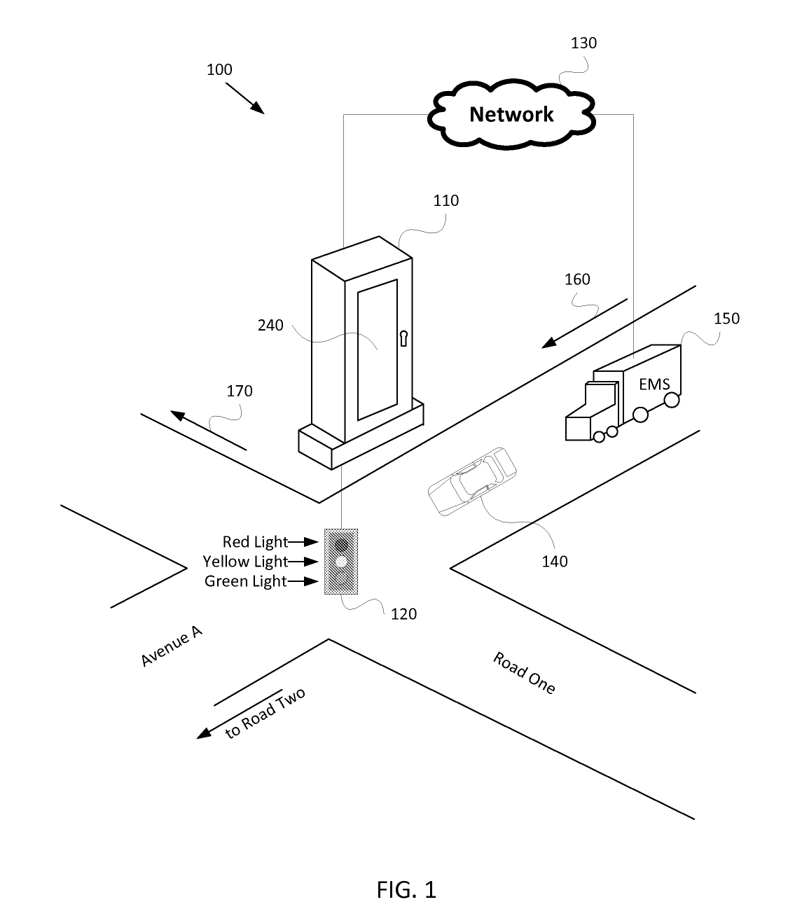

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Generally, traffic controller cabinets are aesthetically displeasing. Often, these cabinets are covered with spray paint, posters, and advertisements. After a short while, these posters and advertisements become out-of-date, and wind blows them down onto the street, causing litter. Advertisements are rarely, if ever, related to vehicle or pedestrian traffic. Disclosed embodiments disclose traffic controller cabinets from serving as a canvas for vandalism and fly-away posters.

Also with an increased population or travelers, more traffic accidents and collisions are subject to an emergency vehicle response. When a driver hears an emergency vehicle siren, the driver does not always know from which direction the emergency vehicle is approaching nor which direction the emergency vehicle is going. The driver does not know whether to go or stop. In response, the driver merges right and slows his vehicle to a stop, not knowing that the emergency vehicle may need to turn right or occupy the space in which the cars are stopped. Disclosed embodiments notify drivers of the direction from which an emergency vehicle is approaching, and how to respond to clear a desired path for the emergency vehicle.

To aid distressed citizens in receiving a rapid response from EMS, firefighters, and police, municipalities have installed emergency call button cabinets at various locations. Municipalities that face strong financial challenges cannot afford to install phone line infrastructure for emergency call button cabinets, even when the citizens want the city to install emergency call button cabinets. Disclosed embodiments disclose a cost effective way to install emergency call button cabinets at locations readily accessible to emergency situations, without substantial costs of phone line infrastructure installation. Also, in light of financially challenged municipalities, disclosed embodiments disclose a new means by which cities can generate revenue, such as by leasing space to an advertiser.

Disclosed embodiments include an apparatus, system, and method to inform street traffic of locally relevant information.

The disclosed embodiments increase access to locally relevant information along a street. Disclosed embodiments increase local government's ability to quickly discriminate a message to a geographically specific audience. Disclosed embodiments will likely decrease the amount of traffic controller cabinets that are vandalized. Disclosed embodiments provide distinct technical advantages that can address an obstacle local governments have in installing emergency phone systems, distributed throughout the jurisdiction. Disclosed embodiments increase locations for electronic advertisement space. Disclosed embodiments can improve emergency vehicle response times.

Disclosed embodiments, described herein, use an electronic display show display content to on-street traffic and sidewalk traffic along-side the street (together “street traffic”). An electronic display can be mounted on or placed within a structure that is visible to street traffic. For example, an electronic display may appear on or within a kiosk, a traffic control cabinet (“TCC”), or a railroad cross bar control cabinet. According to the present disclosure, an electronic display may appear in any location where its associated controller is coupled to traffic signal information.

FIG. 1 illustrates a traffic signal controlled street intersection 100 that provides electronic dissemination of information to street traffic according to embodiments of the present disclosure. The traffic signal controlled street intersection 100 contains one or more traffic control cabinets 110 and one or more traffic signals 120. Each traffic signal 120 is communicably coupled to at least one TCC 110. Each traffic control cabinet 110 is communicably coupled to at least one network 130. The network 130 is communicably coupled to one or more traffic control operation centers (not shown). The traffic signals 120 direct passenger vehicles 140, commercial vehicles (not shown), and emergency response vehicles 150 that drive on the streets. Certain emergency vehicles 150 are communicably coupled to the network 130, and are capable of communicating location, emergency mode/status, direction, and route. The arrows 160 and 170 indicate the direction of traffic flow on each of the intersecting streets (Avenue A and Road One).

In certain embodiments, the intersection 100 includes a plurality of traffic control cabinets 110, with one or more that is fewer than the whole plurality of traffic control cabinets 110 is coupled to the network 130. Also in that embodiment, the remainder of the plurality of traffic control cabinets 110 are communicably coupled to the one or more traffic control cabinets 110 that are coupled to the network 130. In certain embodiments, a portion of the traffic control cabinet 110 is covered by an anti-graffiti coating, preferably a substantial portion or a whole portion.

Traffic signals 120 pass through a sequence of states. One sequence of traffic signal states may include a red light state followed by a green light state followed by a yellow light state followed by a return to the red light state. Another sequence of traffic signal states may include a red-light-red-left-turn-signal state followed by a red-light-green-left-turn-signal state followed by a red-light-yellow-left-turn-signal state followed by a green light state followed by a yellow light state followed by a return to the red-light-red-left-turn-signal state. One skilled in the art will appreciate that a traffic signal may traverse through a different sequence of traffic signal states. The traffic signal 120 is configured to send a signal indicating the state of the traffic signal 120 to the TCC 110.

In certain embodiments, the network 130 is a traffic control network 130. The network 130 may be implemented in a known manner, such as in any one or combination of: an Internet Protocol (IP) communication, a HyperText Transmission Protocol (HTTP) communication over the Internet (i.e., the world wide web), and a Virtual Private Network (VPN) secured by authentication and encryption processes. The network 130 may be implemented as a municipal mesh network. The network 130 enables the TCC to communicate with and among one or more of the traffic control cabinets 110, traffic control operations centers (not shown), traffic control signals 120, vehicles (140, 150), telephones, and authorized government agents, neighborhood agents, and third-party advertising agents (not shown).

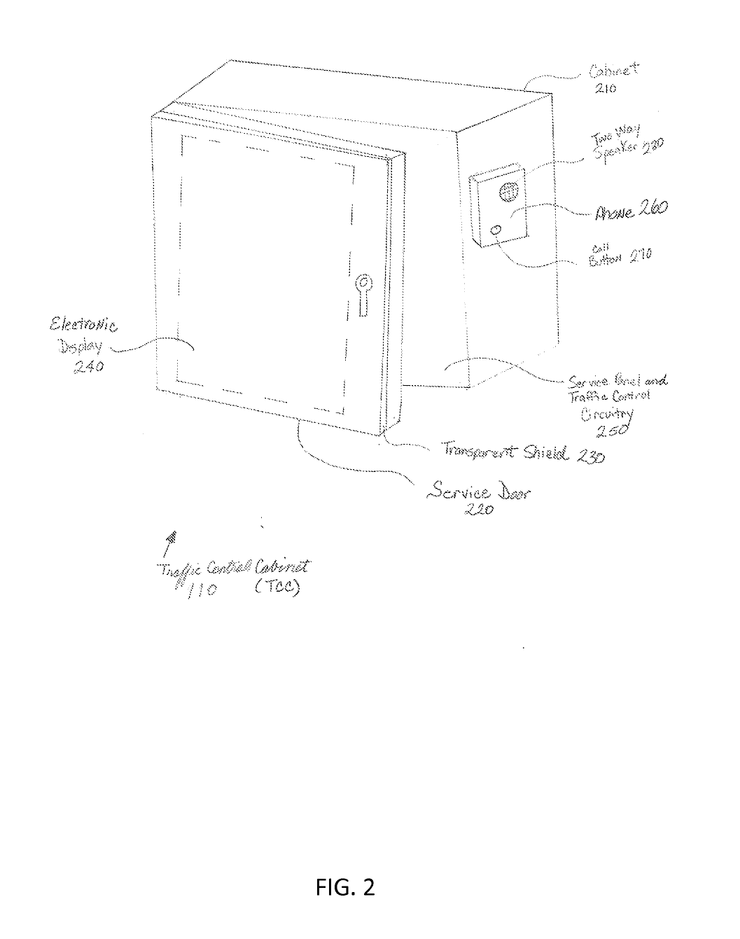

FIG. 2 illustrates a TCC 110 that provides electronic dissemination of information to street traffic according to the present disclosure. The TCC 110 includes a cabinet 210 and a service door 220, which together form an enclosure. The cabinet 210 is configured to store and to provide structural support to the traffic control circuitry 250 inside. The enclosure is configured to store elements inside the TCC 110 and to provide structural support to the elements inside and mounted onto the TCC 110. The enclosure may be made of metal, metal alloy, or other suitable enduring material. The enclosure is configured to protect its internal elements from environmental factors. Environmental factors include, but are not limited to precipitation, condensation, or other moisture, sunlight, heat, dust, dirt, animal tampering, and projectiles.

The service door 220 is pivotally mounted along a front edge of the cabinet 210. The service door 220 contains a closure mechanism for locking and opening and closing the door 220. The closure mechanism may be a lock, a latch, a handle, a button configured to pop open the service door 220, thereby separating a portion of the service door 220 from the cabinet 210. In certain embodiments, the service door 220 spans the entire front face of the TCC 110. In certain embodiments, the service door 220 extends only across a portion of the front of the TCC 110. In certain embodiments, the service door 220 is formed in two portions of equal or unequal sizes. The two portions of the service door 220 can be mounted to swing open in opposite directions.

The TCC 110 includes an electronic display 240. In certain embodiments, the electronic display 240 is mounted or adhered to the front outward facing portion of the service door 220. In certain embodiments, the electronic display 240 is mounted or adhered to the cabinet 210. In other words, the electronic display 240 is mounted to or adhered to a front, rear, or side of the TCC 110. In certain embodiments, the TCC 110 includes a plurality of electronic displays 240 that are mounted to or adhered to a side, top, or rear façade of the cabinet 210. An electronic display 240, preferably, does not overlap the closure mechanism of the service door 220. In certain embodiments, the electronic display 240 is inside the cabinet 210, with the screen of the electronic display 240 facing toward a substantially transparent façade of the cabinet 210, also facing the screen of the electronic display 240 outward to be visible to street traffic. In certain embodiments, the electronic display 240 makes up a removable portion of at least one service door 220. The electronic display may fit snugly in a hole in service door 220, wherein that hole that is substantially the same size as the electronic display 240. The electronic display 240 is configured to show, such as by displaying on a screen, information in video format, graphical format, textual format, or a combination thereof. In one example embodiment, the electronic display 240 is a liquid crystal display (“LCD”). In certain embodiments, the electronic display 240 is a touch screen LCD. In another example, the electronic display 240 is an e-ink display or other electronic paper display. In another embodiment, the electronic display 240 is a touch screen e-ink display or other electronic paper touch screen display. An e-ink or electronic paper display is relatively inexpensive and provides cost benefits over several other known display technologies.

The TCC 110 can include a substantially transparent shield 230 that covers the electronic display 240 and protects it from vandalism (e.g., graffiti). In certain embodiments, the substantially transparent shield 230 protects the electronic display 240 from environmental factors. Environmental factors include, but are not limited to precipitation, condensation, or other moisture, sunlight, heat, dust, dirt, scratches, animal tampering, and projectiles. The transparent shield 230 covers a portion of the electronic display 240. In certain embodiments, the transparent shield 230 covers a substantial portion of the electronic display 240, including covering all of the screen. The substantially transparent shield 230 includes an anti-graffiti coating. Examples of anti-graffiti coatings include anti-graffiti paint, anti-graffiti gel, anti-graffiti polymer, anti-graffiti acrylate, and anti-graffiti wax. An anti-graffiti coating allows graffiti (e.g., permanent markers, paint, spray cans, and ink) to be repeatedly removed without loss of performance. In certain embodiments, the anti-graffiti coating of the substantially transparent shield 230 is applied atop the electronic display 240.

In certain embodiments, the transparent shield 230 is made of a shatter resistant material. In certain embodiments, the transparent shield 230 is scratch-resistant material. Examples of shatter resistant material include any one or combination of the following: shatter-proof glass, Corning® Gorilla® protective glass, fiberglass, plastic, polyurethane, or other similar material. In certain embodiments, the transparent shield 230 is removably coupled to the electronic display 240 or the service door 220, enabling easy access for cleaning its interior and exterior surfaces. In certain embodiments, the transparent shield 230 is mounted onto the front facade of the service door 220, creating an air tight sealed compartment that encapsulates the electronic display 240. In certain embodiments, the transparent shield 230 is coupled to the electronic display 240. In certain embodiments, the transparent shield 230 is inside the TCC 110 enclosure and mounted to the interior side of the front façade of the service door 220. In certain embodiments, the transparent shield 230 makes up a substantial portion of the service door, wherein a small portion of the service door 220 frames the perimeter of transparent shield 230. Certain embodiments of the substantially transparent shield 230 include an anti-graffiti coating and do not include a shatter resistant material

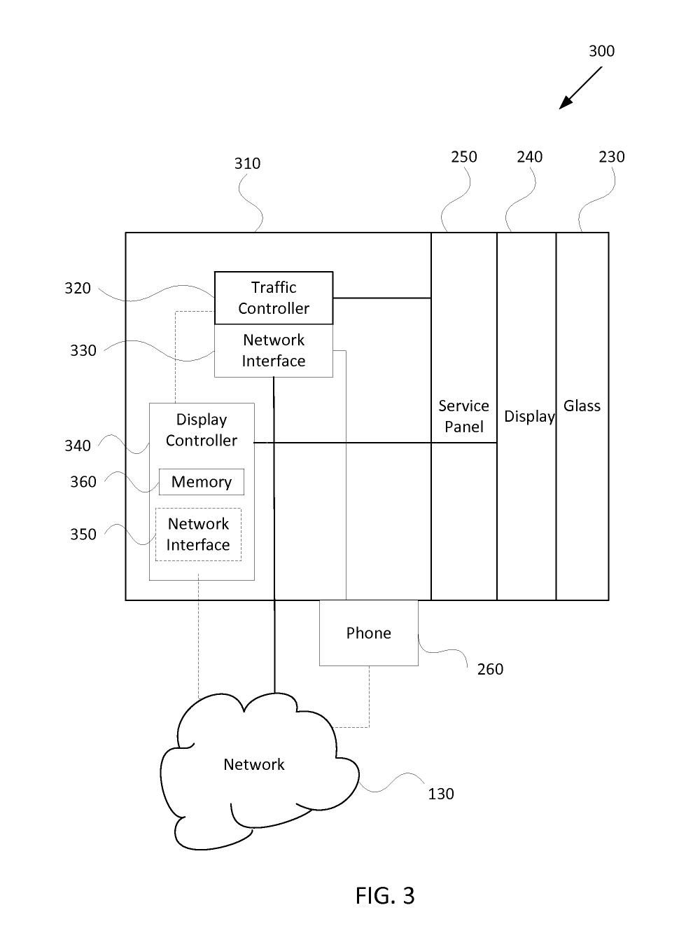

In certain embodiments, the electronic display 240 and the transparent shield 230 are separate from the TCC 110, and are communicably coupled to the TCC 110 via a wired or wireless coupling and communication. In these certain embodiments, the electronic display 240 and its transparent shield 230 may be located on a separate structure, such as a kiosk, pole, a utility company service box, or a wall. In these certain embodiments, the display controller 340 associated with the electronic display 240 is separate from the TCC 110, and communicably coupled to the controller (310, 320) via a wired or wireless coupling and communication (see FIG. 3). These certain embodiments enable the electronic display 240 to be located in a place better suited to disseminate information to street traffic, when the TCC 110 is not the selected suitable location.

In the exemplary embodiment, the TCC 110 includes a phone 260. The phone may be an emergency phone, containing a call button 270 that upon actuation initiates a call to the geographically local emergency telephone dispatcher (e.g., 911 operator). In a certain embodiment, the phone 260 includes a hand set configured to receive voice signals through a microphone and to output voice signals through a speaker. An exemplary phone 260 includes a two way speaker 280 that is configured to receive and transmit voice and sound signals of a user, as a microphone. The two way speaker 280 is also configured to receive and output voice and sound signals to the user, as a speaker. The phone 260 may be an element external to the TCC 110 enclosure, mounted to a side of the cabinet 210 or a front portion of the service door 220. The phone may be a partially external element that fits snugly in a hole that is in the side of the cabinet 210 or a front portion of the service door 220, wherein that hole that is substantially the same size as the phone 260. The phone may be an internal element, mounted to or fitting snugly within a hole in the side of the cabinet 210 or in a front portion of the service door 220, wherein the hole is substantially the same size as the phone 260. In certain embodiments, the phone 260 includes a twelve (12) button telephone keypad, enabling a user to press a sequence of numbers to call a user-dialed telephone number.

The TCC 110 includes traffic control circuitry 250. The traffic control circuitry 250 may also be described as the service panel 250. Traffic control circuitry 250 is within the enclosure of the TCC 110, and preferably inside the cabinet 210. The traffic control circuitry 250 comprises electrical components configured to control one or more traffic signals 120.

FIG. 3 illustrates a block diagram of selected electrical and electronic components of the TCC 110 in FIG. 2. Although certain details will be provided with reference to the components of the control system 300 of FIG. 3, it should be understood that other embodiments may include more, less, or different components. The TCC 110 includes the control system 300. The traffic control system 300 is configured to enable the TCC 110 to provide electronic dissemination of information to street traffic.

Control system 300 includes at least one programmable controller 310, traffic control circuitry 250, a network interface 330 communicably coupled to a network 130, and an electronic display 240. The control system 300 may also include a telephone 260. The control system 300 is configured to control one or more functions of the TCC 110, including providing electronic dissemination of information to street traffic.

The controller 310 is coupled to traffic control circuitry 250, enabling the traffic signals 120 to follow instructions from the traffic controller 320. The controller 310 is coupled to a network interface 330, enabling the controller 310 to communicate with the network 130. In certain embodiments, the controller 310 includes the network interface 330. In other embodiments, the network interface 330 directly or indirectly connected the controller 310.

In one embodiment, the controller 310 includes a traffic controller 320 that is coupled to the traffic control circuitry 250 and to the network interface 330. The traffic control circuitry 250 is configured to control at least one traffic signal 120. The connection between the traffic control circuitry 250 and the traffic controller 320 enables the traffic controller 320 to provide instructions to traffic signal 120. The connection between the traffic controller 320 and the network interface enables the traffic controller 320 to communicate with the network. In certain other embodiments, the traffic controller 320 is the controller 310. In an example embodiment, the traffic controller 320 is configured to communicate with a communication system of a vehicle (140,150), thereby communicating with the vehicle (140,150).

In an example embodiment, the controller 310 includes a display controller 340. In certain embodiments, the traffic controller 320 includes the display controller 340. In certain other embodiments, traffic controller 320 is coupled to and communicates with a display controller 340, also enabling display controller 340 to communicate with the network 130 via network interface 330. In other embodiments, the display controller 340 is not coupled to the traffic controller 320, and the display controller 340 includes its own network interface 350 for communicating with the network 130. Using the connection between traffic controller 320 and display controller 340, traffic controller 320 may forward or send a signal indicating a state of the traffic signal 120 to the display controller 340. Also using the connection between traffic controller 320 and display controller 340, traffic controller 320 may forward or send information regarding a state of the traffic signal 120 to the display controller 340.

In response to receiving the state of the traffic signal 120, display controller 340 may select display content to show on electronic display 240. Display controller 340 may make its selection of display content based on the state of the traffic signal 120 or based on information regarding a state of the traffic signal 120 to the display controller 340. Display controller 340 may also make its selection of display content based on any one or combination of the following: a communication with an emergency vehicle 150, information determined from a communication with an emergency vehicle 150, a communication regarding an emergency vehicle 150, information regarding local conditions, and information received from a local authority, time of day, an ambient temperature measurement, and a measurement of air concentrations of pollen, ozone, or pollutants. The ambient temperature measurement information may be received from the network 130 or received from a thermometer directly coupled to the traffic control circuitry 250. Examples of local conditions include, but are not limited to a local crime report or warning, a report of traffic conditions, and a reminder of election day.

The display controller 340 is further coupled to electronic display 240. For example, the display controller 340 provides content for display on the electronic display 240. The display controller 340 also detects human contact with the touch screen of the electronic display 240. The display controller 340 is configured to detect the location of the physical contact with the touchscreen of the electronic display 240. According to the present disclosure, certain content for display includes one or more user controls (e.g., buttons or keys) that upon physical contact provide specific input to the control system 300. The physical contact with a user control provides a user input signal to the controller 310. Display controller 340 is designed and configured to ensure that every button pressed (e.g., actuation of a user control) on the electronic display 240 is deliberate. The display controller 340 may transmit the user input (e.g. indicated user command) signal to the network 130. The display controller 340 may also transmit the user's specific input resulting from the user input signal to the network 130. The display controller 340 is configured to provide display content prior to a detection of customer contact, such as in an alert mode, or an advertising mode of the traffic control cabinet's 110 control system 300. While display controller 340 is in alert mode, display content containing an advertisement cannot be selected. While display controller 340 is in advertising mode, display content containing an advertisement may be selected. While display controller 340 is communicably coupled to the network 130, the electronic display 240 provides access to web-pages for a user.

The control system 300 includes a display memory 360. The display controller 340 is coupled to and communicates with a display memory 360. In certain embodiments, display memory 360 is included within the display controller 340. In certain other embodiments, the display memory 360 is part of the traffic control circuitry 250, and display controller 340 is coupled to the traffic control circuitry 250. The display memory 360 stores display content. The display memory 360 may include any suitable volatile or non-volatile storage and retrieval device(s). For example, the display memory 360 can include any electronic, magnetic, electromagnetic, optical, electro-optical, electro-mechanical, and/or other physical device(s) that can contain, store, communicate, propagate, or transmit information. The display memory 360 can store data and instructions for use by the display controller 340. For example, the instructions stored in the display memory 360 are configured to cause the display controller 340 to display graphical or textual information on the electronic display 240. The display controller 340 accesses the display content stored in display memory 360. The display controller 340 shows display content on the electronic display 240 based on the accessed content. In an alternative embodiment, the display controller 340 is configured to cause the electronic display 240 to show display content provided by the network 130, wherein the selected display content is not stored in display memory 360, but instead, stored in a remote memory external to the traffic control cabinets 110, in a certain embodiment, the instructions stored in the display memory 360 are configured to cause the display controller 340 to receive or retrieve display content provided by the network 130, wherein the selected display content is not stored in display memory 360, but instead, stored in a remote memory external to the traffic control cabinets 110. In certain embodiments, instructions of the display memory 360 are configured to cause those controller (310, 320) to perform the functions of the display controller 340; these embodiment include those wherein the controller 310 or the traffic controller 320 include the display controller 340, and those wherein the controller 310 or the traffic controller 320 perform the functions of the display controller 340. In certain embodiments, the instructions stored in display memory 360 are configured to cause the display controller 340 to generate display content and store the generated display content in display memory 360.

While the control system 300 is in alert mode, the display controller 340 may cause the electronic display 240 to refrain from showing display content that is an advertisement or other category of display content unrelated to public safety. The display memory 360 may store display content including information in video format, graphical format, textual format, or a combination thereof. While display controller 340 is communicably coupled to the network 130, the display controller 340 may receive display content via the network 130 and cause that received display content to be stored in display memory 360. Also, while display controller 340 is communicably coupled to the network 130, a remote authorized user may delete or change portions of the display content stored in display memory 360.

The telephone 260 may be directly coupled to the network 130. In an alternative embodiment, the telephone 260 is indirectly coupled to the network 130 via a coupling with a network interface of the controller 310. That is, the telephone 260 may be coupled to a network interface 330 of the traffic controller 320 or to a network interface 350 the display controller 340. In a certain embodiment, the telephone 260 is coupled to the display controller 340. In that embodiment, the display memory 360 includes instructions configured to cause the display controller to: send and receive voice signals; initiate and conduct a phone call (e.g., using Voice over internet protocol (“VoIP”)). While the telephone 260 is in communication with the network 130, a user is able to send and receive voice signals (e.g., using VoIP).

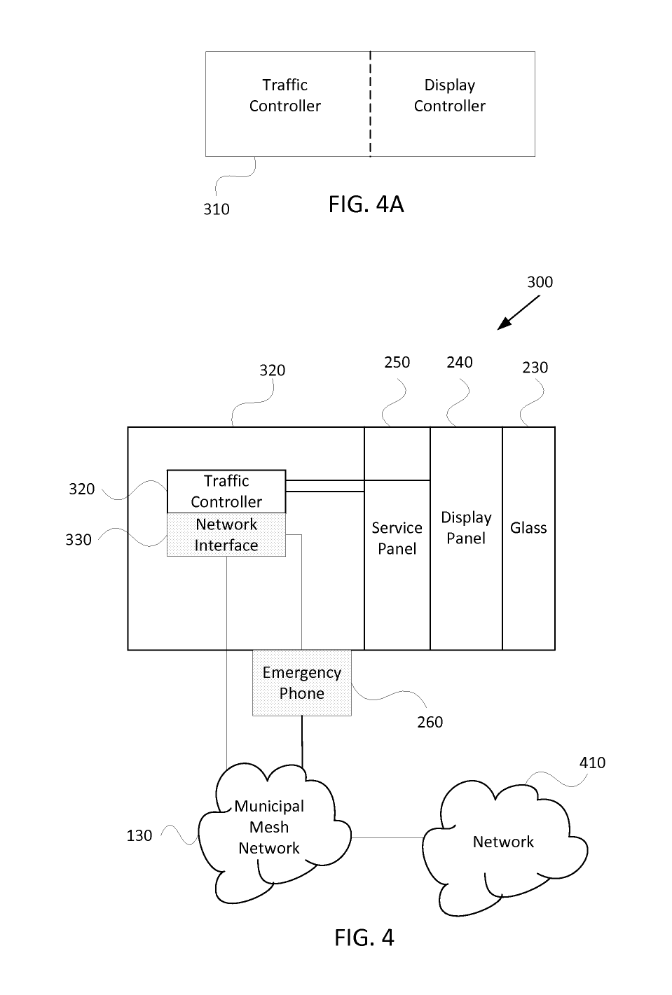

FIG. 4 illustrates an alternative embodiment of control system 300, wherein the network 130 is a municipal mesh network communicably coupled to a second network 410. The municipal mesh network and the second network 410 may be implemented in a known manner, such as by utilizing any one or combination of: an Internet Protocol (IP), a HyperText Transmission Protocol (HTTP) communication over the Internet (i.e., the world wide web), and secured by authentication and encryption processes to create a Virtual Private Network (VPN). Also, the municipal mesh network may be implemented using wireless fidelity (“Wi-Fi”) or wireless local area network standards (WLAN). The second network 410 may be implemented as a telephone network (e.g. plain old telephone service (POTS)).

FIGS. 4 and 4A illustrate an alternative embodiment of the controller 310, wherein the display controller functions and traffic controller functions are performed by one controller 310, 320. FIG. 4 illustrates an embodiment wherein network interface 330 is the sole element enabling TCC 110 to communicate with the network 130.

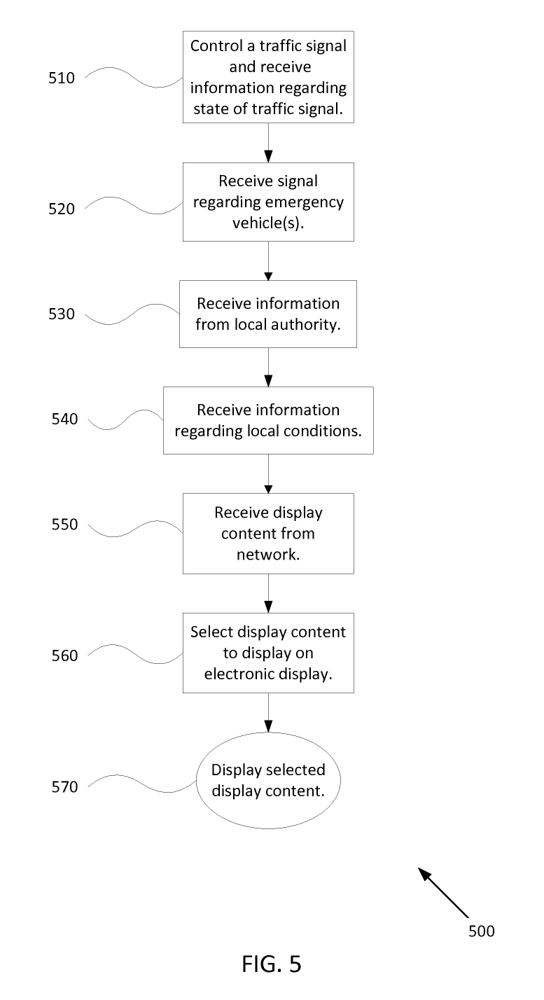

FIG. 5 illustrates a high level flow chart of a process and method 500 for providing electronic dissemination of information to street traffic that is described in the present disclosure. This process can be performed, for example, by one or more TCC control systems 300, referred to in the singular as “the system.” The process can be implemented by executable instructions stored in a non-transitory computer-readable medium that cause one or more TCC control systems 300 to perform such a process.

This method 500 allows pedestrians and drivers (including non-motorized vehicle riders) who are at or within a visible distance of the electronic display 240 (visible distance meaning a distance from the electronic display 240 at which the electronic display 240 is humanly legible) to receive locally relevant information. One example of locally relevant information is information regarding a traffic signal state, such as: the current traffic signal state; the amount of time a traffic signal has been in its current state; the next traffic signal state; the amount of time a traffic signal will remain in its current state, which is the same as the amount of time remaining before the traffic signal will change to the next traffic signal state. Another example of locally relevant information is geographically local news or locally relevant emergency messages, both of which may originate from a city government agent of the city in which the TCC is located, or may originate from a resident of the neighborhood city in which the TCC is located. A further example of locally relevant information includes: a substantially precise distance that an emergency vehicle 150 is from the electronic display 240; a direction from which the emergency vehicle 150 is approaching the street intersection, a street on which the emergency vehicle 150 is driving; a direction the emergency vehicle 150 is routed to turn at the street intersection 100. Locally relevant information may include public transportation information, such as a bus schedule for a bus route that includes the street intersection 100; an estimated time of arrival for a next bus approaching the street intersection or a bus stop nearby the street intersection 100.

The system controls a traffic signal at a street intersection in block 510. Together with controlling a traffic signal, the system receives information regarding the state of the traffic signal (block 510). Receiving information regarding the state of the traffic signal can include receiving from another device or process. For example, as part of this step 510, the traffic controller (310, 320) may cause a traffic signal to enter a traffic signal state and at the same time the system (e.g. a controller 310, 320, 340, 250) may receive data from a traffic signal 120, the data indicating the current state of the traffic signal 120. As another example, as part of this step 510, the traffic controller (310, 320) may cause a traffic signal to remain in a traffic signal state for a selected time period and at the same time the system (e.g. a controller 310, 320, 340) may receive data from the controller (310, 320), the received data indicating an amount time remaining that the traffic signal will remain in the traffic signal state.

The system receives information regarding locally relevant information in blocks 520, 530, and 540. In block 520, the system receives a signal regarding emergency vehicles. The signal may indicate the presence of an emergency vehicle within a certain distance of the street intersection controlled by the system. The signal may indicate whether or not the emergency vehicle is currently responding to an emergency situation (e.g. in emergency mode). In response to receiving a signal from an emergency vehicle in emergency mode, the system (i.e., the instructions in the display memory 360) may cause the display controller 340 to enter an alert mode, wherein display content containing advertisements cannot be selected in block 560.

In block 530, the system receives information from one or more local authorities. In response to receiving information from a local authority, the system may assign or association the information with a level of urgency or a level of hierarchy. The level of hierarchy may be based on the level of authority of the source of the information.

In block 540, the system receives information regarding local conditions. Information regarding a local condition may originate or be received from a government agent, an authorized neighborhood agent, a traffic control operation center, or a vehicle. For example, a stalled vehicle may send a signal containing information indicating its location (that is nearby the system) and stalled status. Also, for example, neighborhood agent may send a message indicating a location (that is nearby the system) and stalled status of a vehicle.

In block 550, the system receives display content from the network 130. The display content received from the network 130 may originate or be received from an authorized advertisement agent, a government agent, an authorized neighborhood agent, a traffic control operation center, or a vehicle.

In block 560, the system selects display content to display on electronic display 240. The system may, in response to receiving information or a signal in blocks 510, 520, 530, 540, and 550, select display content that is stored, generated, received, or a combination thereof. In response to receiving information or a signal regarding an emergency vehicle, the system may select display content that is associated with the information or signal. In response to receiving information or a signal regarding an emergency vehicle, the system may select display content that is stored in display memory 360. In response to receiving a particular information or a particular signal, the system may generate display content and select to show the generated display content. The generated display content may include a combination of stored display content and generated display content. For example, in response to receiving a signal indicating a distance away that an approaching emergency vehicle is away from the intersection 100 controlled by a traffic signal, which is controlled by the system, the system (i.e., display controller 340) may select to show stored display content containing a message indicating that an emergency vehicle is approaching the intersection from a particular distance away, wherein the particular distance is filled in by generated display content. The generated display content may be generated in response to: determining or calculating how far away the emergency vehicle is; determining or calculating from which direction the emergency vehicle is approaching.

The system may be programmed to not select display content in response to a receiving a particular signal or a particular information. The system (e.g., a controller having display controller functions 310, 320, 340) may select a series of display content based on the urgency of the information received, based on the hierarchical level of authority from where the information was received (i.e. where the information originated), or based on information that an urgency has expired. For example, the system may select to display a series of display content, wherein the series includes displaying content A that is urgent for the next 5 minutes, followed by content B that is urgent for the next 8 minutes. In this example, the hierarchical level of authority for content A and B are the same, and the level of urgency of content A is higher than content B's. In this example, before displaying content B, the system receives information that extends the display time for content A by 6 minutes, thereby causing a showing of content B to not be displayed due to its expiry after showing content A for 8 minutes.

In block 570, the system (e.g., a controller having display controller functions 310, 320, 340) displays the display content selected in block 560, preferably in order of priority, hierarchy, and non-expiry.

One example of a specific use of the process 500 in FIG. 5 involves providing electronic dissemination of information to street traffic, wherein the information directs along street traffic to clear a path for an approaching emergency vehicle 150. The emergency vehicle 150 may include one or more vehicles within a United States of America's President motorcade.

In block 520, the system receives a signal regarding an emergency vehicle, wherein the signal indicate that the emergency vehicle 150 is in emergency mode. The signal may indicate that the emergency vehicle 150 is traversing a route that includes the street intersection controlled by traffic signals 120 that are controlled by the system. As shown in FIG. 1, the signal may indicate that the emergency vehicle is on Avenue A, travelling in the direction of the normal flow of traffic, as shown by arrow 160. For example, the route of the emergency vehicle may include a turn at the intersection of Road One and Avenue A, wherein after the turn, the emergency vehicle will travel on Road One in the direction of the normal flow of traffic, as shown by arrow 170.

Together with the information received in block 520, or as a part of the step of block 520, the system may also receive display content to show on electronic displays 240 located at the intersection of Avenue A and Road One disseminate (Block 550). The display content may include: (1) instructions for drivers travelling on Avenue A to merge to the left side of Avenue A to clear a path for the approaching emergency vehicle 150 to traverse Avenue A in the direction of arrow 160 and to turn on to Road One to travel in the direction of arrow 170; or (2) instructions for drivers travelling on Road One to merge to the left side of Road One to clear a path for the approaching emergency vehicle 150 to turn onto and traverse Road One in the direction of arrow 170.

In block 540, the system receives information regarding local conditions, wherein the information indicates that the intersection of Avenue A and Road Two (the next street beyond Road One) is closed for the next 20 minutes as a result of a vehicular collision.

In block 530, the system receives information from a local authority, wherein the local authority is a law enforcement agent and the information includes instructions to direct traffic away from the intersection of Avenue A and Road for the next 20 minutes.

Together with the information received in blocks 530 or 540, or as a part of the steps of blocks 530 or 540, the system may also receive display content to show on electronic displays 240 located at the intersection of Avenue A and Road One disseminate (Block 550). The display content may include: (1) instructions for vehicles travelling on Avenue A to turn onto Road One and warning street pedestrians and drivers of the vehicular collision and temporary closure of the intersection of Avenue A and Road Two; or (2) instructions for vehicles travelling on Road One to avoid turning onto Avenue A to travel toward Road Two (in the direction of arrow 160) and warning street pedestrians and drivers of the vehicular collision and temporary closure of the intersection of Avenue A and Road Two.

In block 560, the system selects display content to display on electronic display 240, wherein the selection is based on information received in blocks 510, 520, 530, and 540. The system may select a series of display content based on order of priority, hierarchy, and non-expiry. For example, in response to an approaching emergency vehicle and an intersection closure, and as part of selecting display content, the system may rank the emergency vehicle at a hierarchical level above the intersection closure. As shown in FIG. 1, the system may, in response to the approaching emergency vehicle 150, select to first display a message instructing passenger vehicles 140 and commercial vehicles (not shown) travelling on Avenue A to merge to the left side of Avenue A to clear a path for the approaching emergency vehicle 150 to traverse Avenue A in the direction of arrow 160 and to turn on to Road One to travel in the direction of arrow 170. Similarly, the system may select to first display a message instructing passenger vehicles 140 and commercial vehicles travelling on Road One to merge to the left side of Road One to clear a path for the approaching emergency vehicle 150 to turn onto and traverse Road One in the direction of arrow 170. The system may, in response to the intersection closure, select to secondly display a message instructing vehicles travelling on Avenue A to turn onto Road One and warning street pedestrians and drivers of the vehicular collision and temporary closure of the intersection of Avenue A and Road Two. Similarly, the system may, in response to the intersection closure, select to secondly display a message instructing vehicles travelling on Road One to avoid turning onto Avenue A to travel toward Road Two (in the direction of arrow 160) and warning street pedestrians and drivers of the vehicular collision and temporary closure of the intersection of Avenue A and Road Two.

In certain embodiments of block 560, selecting display content to display on electronic display 240 includes selecting display content to display on a plurality of electronic displays 240. In certain embodiments, the system selects the same display content for each electronic display 240 of the plurality of electronic displays. In certain embodiments, the system selects different display content for each electronic display 240 of the plurality of electronic displays. For example, in reference to FIG. 1, the system selects display content for each electronic display 240 of an embodiment of TCC 110 that includes four electronic displays 240, one on each of the four sides. In other words, the TCC 110 includes a first electronic displays 240 on the service door 220; a second electronic display 240 on the rear of the TCC (i.e., the side parallel with and opposite to the closed service door); a third electronic display 240 on the left side (i.e., the side facing traffic travelling on Avenue A from Road Two toward Road One), and a fourth electronic display 240 on the right side (i.e., the side facing traffic travelling on Avenue A traveling toward Road One, such as the emergency response vehicle 150). In response to a predetermined amount of time before the traffic signal 120 changes to a selected traffic signal state, such as a green light state to allow vehicles 140, 150 traveling on Road One in the direction of the arrow 170 toward Avenue A to go forward through the intersection of Avenue A and Road One, the system selects to not display content (e.g., shut off content already displayed) on the first electronic display 240. The system selects to display a second display content on the second electronic display, a third display content on the third electronic display, and a fourth display content on the fourth electronic display. The traffic controller 320 sends a signal to the system indicating an amount of time (e.g., the predetermined amount of time) before the traffic signal 120 changes to a green state. In this example, traffic traveling in multiple directions can view display content of the TCC 110. However, traffic preparing to drive through an intersection cannot view display content of the TCC 110.

In block 570, the system 300 displays the series of display content selected in block 560, sequentially, in order of priority, hierarchy, and non-expiry.

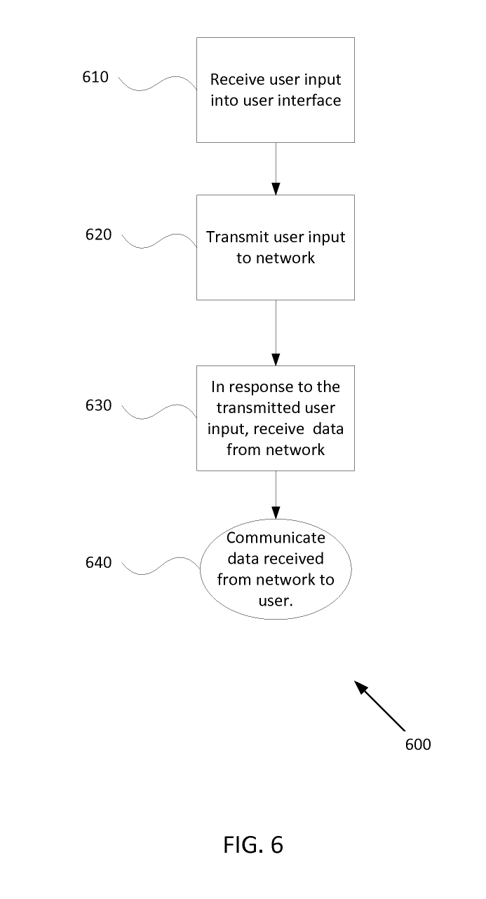

FIG. 6, illustrates a high level flow chart of a process and method 600 for communicating data received from the network 130 to a user.

In block 610, the system receives user input into the user interface. The user interface includes the telephone 260 and a touchscreen electronic display 240, wherein the electronic display 240 is coupled to a display controller 340 configured to receive user input signals and transmit the user input signal to the network 130. In this step 610, a user touches a portion of the user interface (240, 260), indicating the user's command. In response, the display controller 340 receives the user input and determines the user command.

In block 620, the system transmits the user input received in block 610 to the network 130. In this step 620, the display controller 340 transmits the user command to the network 130 via a network interface (330, 350) to which it is coupled.

In block 630, in response to the user input transmitted in block 620, the system receives data from the network 130.

In block 640, the system communicates the data received from the network 130 to the user of block 610 via the user interface. The display controller 340 causes the electronic display 240 to communicate the received data that is graphical, video, and textual. In embodiments that included a telephone 260, the controller causes the telephone to communicate the received data that is a telephonic voice response or telephonic sound.

One example of a specific use of the process 600 in FIG. 6 involves conducting two-way voice communication using a TCC system phone communicably coupled to the network 130. In block 610, the system receives user input into the user interface. In this example, the user interface includes a telephone 260 and a touchscreen electronic display 240 that both receive user input signals and transmit the user input signal to the network 130. In this step 610, a user touches a portion of the user interface (240, 260), indicating the user's command. In response, the controller 310 receives the user input and determines the user command.

In block 610, the user input is user input regarding a voice call. Input regarding a voice call may include, for example, any one or combination of the following: removing a handset, indicating a user command to initiate a dial tone or beginning of a phone call; actuating a call button 270, indicating a user command to initiate a phone call to a phone number to be dialed by the user; actuating a call button 270 after a first actuation of the call button 270, indicating a user command to terminate the initiated phone call; actuating an emergency call button 270 (wherein the call button is specifically configured to dial 911 upon actuation), indicating a user command to initiate an emergency 9-1-1 phone call to an emergency dispatch operator; actuating an emergency call button 270 after a first actuation of the emergency call button 270, indicating a user command to terminate an emergency 9-1-1 phone call to an emergency dispatch operator; and actuating a sequence of buttons on a twelve (12) button telephone keypad, indicating a user command to dial the sequence of numbers or symbols corresponding to the actuated buttons.

Also in block 620, the user input includes a user's sound received into two-way speaker 280. The sound may include any one or combination of an oral message spoken by the user; and filtered or unfiltered ambient noise surrounding the two-way speaker.

In block 620, the system transmits the user input received from block 620 to the network 130. The system may transmit the user input in a transformed format that corresponds to the user command indicated by the user input. The system may use VoIP to communicate the user input.

In block 630, in response to the user input transmitted in block 620, the system, together with the network, executes the user command received from block 610. Also in this step 630, the system transmits the sounds received from the network to the two-way speaker. The system transmits any signals or information received from the network to the controller 310, 320, 340).

In block 640, in response to receiving the sounds transmitted from the network, the two-way speaker 280 plays the sounds from the network at a volume level audible to the user. Also in this step 640, the electronic display 240 shows display content that communicates the result of the user command executed in block 640. The result of the user command executed in block 640 may include any signals or information that the system received from the network and transmitted to the controller (310, 320, 340).

Of course, those having skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all electrical circuitry suitable for use with the present disclosure is not being depicted or described herein. Instead, only so much of electrical circuitry as is unique to the present disclosure or necessary for an understanding of the present disclosure is depicted and described. The remainder of the construction and operation of electrical circuitry 300 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. An apparatus comprising:
at least one electronic display;
traffic control circuitry configured to control at least one traffic signal;
at least one controller coupled to the traffic control circuitry and the at least one electronic display, wherein the at least one controller is configured to display selected display content on the at least one electronic display; and
a communication interface coupled to the at least one controller and a first network, the communication interface configured to communicate with the first network.

2. The apparatus of claim 1, wherein the at least one controller comprises a first controller and a second controller, and wherein one of the first controller and the second controller is a traffic controller and the other is a display controller.

3. The apparatus of claim 2, wherein the display controller is coupled to the network via the communication interface, wherein the communication interface is coupled to the traffic controller.

4. The apparatus of claim 2, wherein the first controller is coupled to the at least one electronic display directly or via a connection to the second controller which is directly coupled to the at least one electronic display.

5. The apparatus of claim 1, wherein the first network comprises a municipal mesh network coupled to a second network comprising at least one of the Internet and a telephone network.

6. The apparatus of claim 1, wherein at least one of:
the at least one electronic display comprises an interactive touch screen display;
the at least one electronic display comprises an e-ink panel; and
a portion of the apparatus comprises an anti-graffiti coating.

7. The apparatus of claim 1, wherein the at least one controller is configured to communicate with an emergency response vehicle.

8. The apparatus of claim 1, wherein the at least one controller is configured to receive a signal indicating a state of the at least one traffic signal.

9. The apparatus of claim 1, wherein the at least one controller is configured to receive the display content from the first network, and wherein the selected display content comprises stored and received display content.

10. The apparatus of claim 1, wherein the selected display content is selected based on at least one of:
communications received from the first network;
a traffic signal state;
a predetermined amount of time before a traffic signal changes to a selected traffic signal state;
a communication with an emergency vehicle;
a communication regarding an emergency vehicle communication;
information regarding local conditions; and
information received from a local authority.

11. The apparatus of claim 1, wherein the at least one controller is further configured to receive a user input signal and to transmit the received user input signal to the first network, and in response to the transmitted user input signal, receive data from the first network.

12. The apparatus of claim 11, wherein the user input signal comprises at least one of:
a first sound signal into a two-way speaker configured to send and receive sound, wherein the two-way speaker is coupled to the at least one controller, the at least one controller configured to send and receive sound signals and to conduct two-way voice communication, and
a user input signal regarding a voice call,
wherein the data received from the first network comprises a second sound signal transmitted to the two-way speaker to be output.

13. A method comprising:
controlling, by a traffic control, at least one traffic signal;
communicating, by a communication interface, with a first network, wherein the communication interface is coupled to the at least one controller and the first network; and
displaying selected display content on at least one electronic display, wherein the at least one electronic display is coupled to at least one controller configured to display the selected display content on the at least one electronic display.

14. The method of claim 13, wherein the at least one controller comprises a first controller and a second controller, and wherein one of the first controller and the second controller is a traffic controller and the other is a display controller.

15. The method of claim 14, wherein the display controller is coupled to the network via the communication interface, wherein the communication interface is coupled to the traffic controller.

16. The method of claim 14, wherein the first controller is coupled to the at least one electronic display directly or via a connection to the second controller which is directly coupled to the at least one electronic display.

17. The method of claim 13, wherein the first network comprises a municipal mesh network coupled to a second network comprising at least one of the Internet and a telephone network.

18. The method of claim 13, wherein at least one of:
the at least one electronic display comprises an interactive touch screen display;
the at least one electronic display comprises an e-ink panel; and
the substantially transparent shield comprises an anti-graffiti coating.

19. The method of claim 13, wherein the at least one controller is configured to communicate with an emergency response vehicle.

20. The method of claim 13, wherein the at least one controller is configured to receive a signal indicating a state of the at least one traffic signal.

21. The method of claim 13, wherein the at least one controller is configured to receive the display content from the first network, and wherein the selected display content comprises stored and received display content.

22. The method of claim 13, wherein the selected display content is selected based on at least one of:
communications received from the first network;
a traffic signal state;
a predetermined amount of time before a traffic signal changes to a selected traffic signal state;
a communication with an emergency vehicle;
a communication regarding an emergency vehicle communication;
information regarding local conditions; and
information received from a local authority.

23. The method of claim 13, further comprising:
receiving a user input signal into the at least one controller, the at least one controller further configured to receive and to transmit the received user input signals to the first network;
transmitting the received user input signal to the first network; and
and in response to the transmitted user input signal, receiving data from the first network.

24. The method of claim 23, wherein the user input signal comprises at least one of:
a first sound signal into a two-way speaker configured to send and receive sound, wherein the two-way speaker is coupled to the at least one controller, the at least one controller configured to send and receive sound signals and to conduct two-way voice communication, and
a user input signal regarding a voice call,
wherein receiving the data from the first network comprises receiving a second sound signal transmitted into the two-way speaker.
